(19) United States
(12) Patent Application Publication
(10) Pub. No.: US 2021/0201245 A1
(43) Pub. Date: Jul. 1, 2021

(54) SYSTEMS AND METHODS FOR PREDICTING AND HANDLING SLACK PERIODS

(71) Applicant: Talkdesk, Inc., San Francisco, CA (US)

(72) Inventors: Katherine Krucek, Deer Park, IL (US); Jason Fama, San Carlos, CA (US); Richard Lawrence, San Diego, CA (US)

(21) Appl. No.: 16/728,655

(22) Filed: Dec. 27, 2019

(51) Int. Cl. G06Q 10/06; G06Q 10/10

(52) U.S. Cl. CPC G06Q 10/063114; G06Q 10/1097

(57) ABSTRACT

A system for predicting slack periods is provided. The system predicts and detects time intervals for an entity (e.g., a contact center) where the amount of available work (e.g., call volume) is less than what can be handled by the number of employees (e.g., agents) that are scheduled to work during the time intervals. These detected intervals are referred to herein as “slack periods”. When slack periods are predicted or detected, the system encourages the employees to perform QM tasks during the slack periods and can even automatically schedule the QM tasks for the employees. To further encourage the completion of QM tasks during slack periods, the system can provide incentives for the employees to complete the QM tasks.

### BACKGROUND

In many businesses, such as contact centers, it may be difficult to find times for employees to perform quality management (“QM”) tasks while also handling their primary duties. QM tasks may include tasks such as performing self-evaluations, receiving coaching from supervisors, or taking part in training or classes.

### SUMMARY

A system for predicting slack periods is provided. The system predicts and detects time intervals for an entity (e.g., a contact center) where the amount of available work (e.g., call volume) is less than what can be handled by the number of employees (e.g., agents) that are scheduled to work during the time intervals. These detected intervals are referred to herein as “slack periods”. When slack periods are predicted or detected, the system encourages the employees to perform QM tasks during the slack periods and can even automatically schedule the QM tasks for the employees. To further encourage the completion of QM tasks during slack periods, the system can provide incentives for the employees to complete the QM tasks.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an illustration of an example system architecture;

FIG. 2 is an illustration of an example system architecture for predicting slack periods and scheduling tasks during the predicted slack periods within the context of the environment of FIG. 1;

FIG. 3 is an illustration of an example method for predicting one or more forecast slack periods;

FIG. 4 is an illustration of an example method for predicting one or more intraday slack periods;

FIG. 5 is an illustration of an example method for sending a notification in response to a slack period;

FIG. 6 is an illustration of an example method for detecting a slack period and for sending notifications in response to the detected slack period; and

FIG. 7 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described within a cloud-based contact center, it will become evident to those skilled in the art that the implementations are not limited thereto.

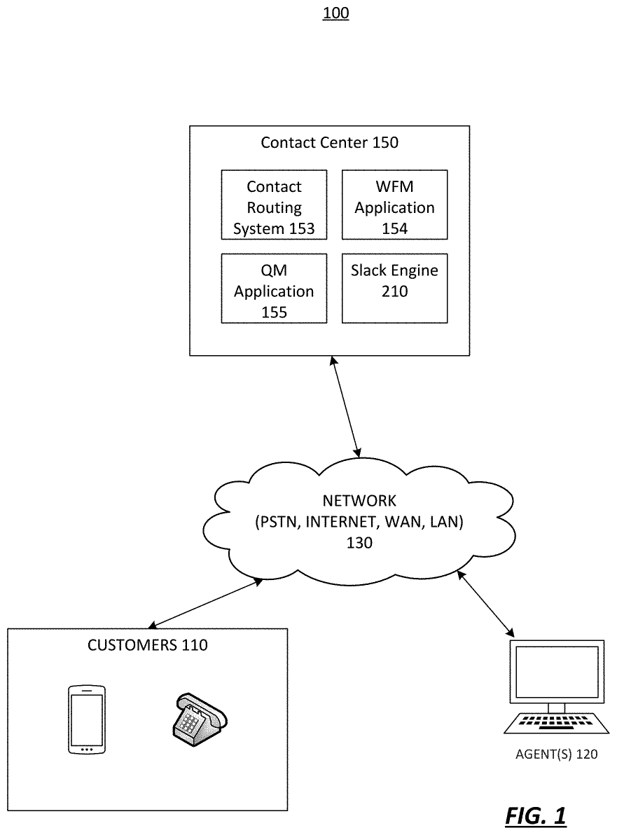

FIG. 1 is an example system architecture 100, and illustrates example components, functional capabilities and optional modules that may be included in a cloud-based contact center infrastructure solution. Customers 110 interact with a contact center 150 using voice, email, text, and web interfaces in order to communicate with the agents 120 through a network 130 and one or more of text or multimedia channels. The system that controls the operation of the contact center 150 including the routing and handling of communications between customers 110 and agents 120 for the contact center 150 is referred to herein as the contact routing system 153. Depending on the embodiment, the contact routing system 153 could be any of a contact center as a service (CCaS) system, an automated call distributor (ACD) system, or a case system, for example.

The agents 120 may be remote from the contact center 150 and may handle communications with customers 110 on behalf of an enterprise. The agents 120 may utilize devices, such as but not limited to, work stations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network. The network types are provided by way of example and are not intended to limit types of networks used for communications.

In some embodiments, the agents 120 may be assigned to one or more queues. The agents 120 assigned to a queue may handle communications that are placed in the queue by the contact center 150. For example, there may be queues associated with a language (e.g., English or Chinese), topic (e.g., technical support or billing), or a particular country of origin. When a communication is received by the contact center 150, the communication may be placed in a relevant queue, and one of the agents 120 associated with the relevant queue may handle the communication.

The contact center 150 may include one or both of a workforce management (“WFM”) application 154 and a quality management (“QM”) application 155. The WFM application 154 may generate forecasts and schedules for the contact center 150 and the agents 120 and may ensure that the contact center 150 complies with all laws and regulations regarding agent 120 work hours. The QM application 155 may maintain or improve the quality of the agents 120 of the contact center 150 by generating and assigning self-evaluation tasks to agents 120, ensuring that agents 120 receive adequate coaching and training, and measuring and reporting on the satisfaction of the customers 110 with respect to their interactions with the contact center 150. As described above, for a busy contact center 150, it may be difficult for agents 120 to fine time to perform QM tasks such as performing self-evaluations and attending coaching or training sessions.

Accordingly, to solve these problems and others, the contact center 150 may further include a slack engine 210. The slack engine 210 is configured to predict or detect what are referred to herein as slack periods for the contact center 150. A slack period is one or more intervals of time where the number of agents 120 assigned to work for the contact center 150, or on a particular queue, exceeds the number of agents 120 that are needed to meet one or more service level goals for the contact center 150 or queue 120.

Once the slack periods are predicted, rather than some of agents 120 be idle or underutilized during the slack period, the slack engine 210 may notify the agents 120 scheduled to work during the slack period and may offer them incentives to work on one or more QM tasks during the slack period. The slack engine 210 may further monitor the number of agents 120 that perform QM tasks during the slack period to ensure that the service level goals of the contact center 150 and/or queue 120 are met.

Note that while the slack engine 210 is described herein with respect to a contact center 150 and one or more agents 120, it is for illustrative purposes only. The slack engine 210 can be used by any entity that schedules employees. Moreover, the slack engine 210 is not limited to the performance of QM tasks but can be used to perform any type of task that can be associated with an entity or employee.

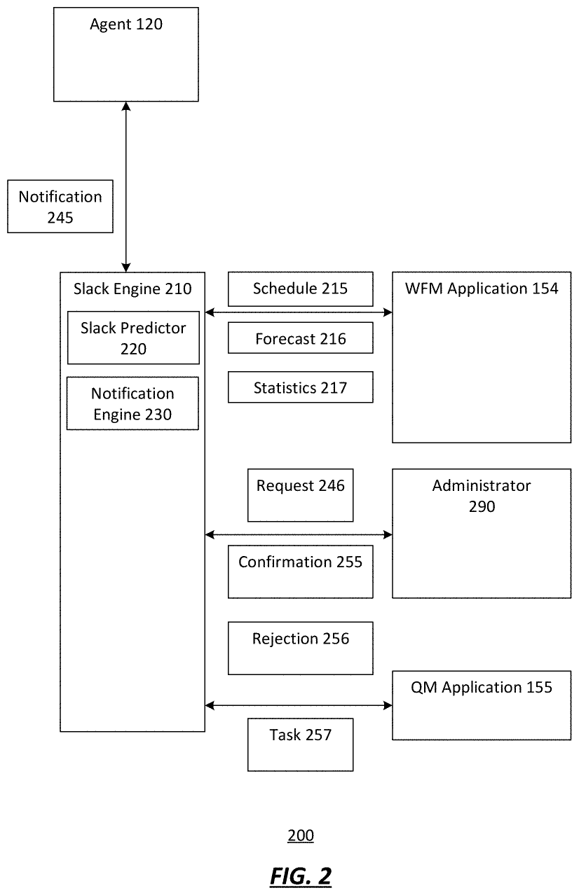

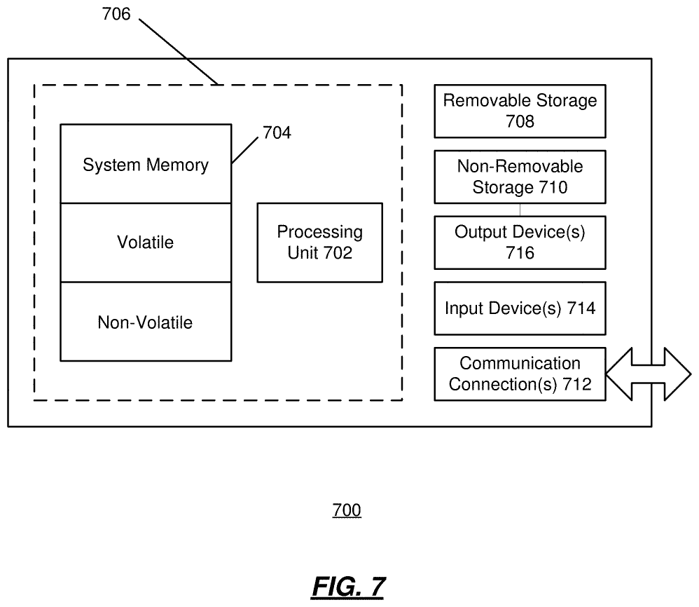

FIG. 2 is an illustration of an example system architecture for incorporating a slack engine 210 into a business or entity such as a contact center 150. As shown the slack engine 210 includes various modules and components such as a slack predictor 220 and a notification engine 230. More or fewer modules or components may be supported by the slack engine 210. The slack engine 210 may further interact with, or may receive data from, one or more of the WFM application 154, the QM application 155, and an administrator 290. Depending on the embodiment, each of the slack engine 210, the WFM application 154, the QM application 155, and the administrator 290 may be implemented together or separately by one or more general purpose computing devices such as the computing system 700 illustrated with respect to FIG. 7.

The slack engine 210 may predict a slack period for one or more intervals of a plurality of intervals. The intervals of the plurality of intervals may each have the same time duration and may correspond to the smallest amount of time that can be scheduled in the contact center 150. For example, depending on the needs of the contact center 150, each interval may have a duration of fifteen minutes, thirty minutes, or one hour. Other time intervals may be used.

As will be described in turn, the slack engine 210 may predict two types of slack periods. The first type of slack period is referred to herein as a forecast slack period and the second type of slack period is referred to herein as an intraday slack period. Other types of slack periods may be predicted. When slack period is used in the present application and claims, it is may refer to one or both of forecast or intraday type slack period. Depending on the embodiment, a slack period may be predicted for an entire contact center 150, may be predicted on a queue by queue basis, or may predicted with respect to a particular agent group or set of agent skills.

Forecast slack periods may be slack periods that are predicted in advance based on a forecast 216 and a schedule 215. The forecast 216 for a contact center 150 may cover a plurality of intervals, and may indicate, for each interval, how busy the contact center 150 (or a particular queue of the contact center 150) is likely to be during each interval. The forecast 216 may be generated by the WFM application 154 based on the historical workload of the contact center 150 including how busy the contact center 150 was in the past at or around the same interval. Any method for generating a forecast 216 may be used.

The schedule 215 for a contact center 150 may have been generated based on the forecast 216 and may cover the same intervals as the forecast 216. The schedule 215 may associate agents 120 with each interval or may associate agents 120 to particular queues for each interval. The schedule 215 may similarly be received from, and generated by, the WFM application 154.

The slack predictor 220 may determine or more forecast slack periods using the forecast 216 and the schedule 215. In particular, the slack predictor 220 may determine intervals of the plurality of intervals where the number of agents 120 assigned to the interval for a queue exceed the number of agents 120 needed to meet the service level goals associated with the queue based on the amount of work for the interval predicted by the forecast 216. Alternatively or additionally, instead of determining slack periods per queue per interval, the slack predictor 220 may determine skill periods per agent group, per contact center 150, or per set of agent skills.

The slack predictor 220 may further predict slack periods using one or more slack rules. The slack rules may be based on criterial such as how many excess agents 120 are required for an interval to be considered part of a slack period or what percentage of the interval is required to be overstaffed for the interval to be considered part of a slack period. Each queue may use different slack rules, and/or different slack rules may be used depending on the time of the day associated with the interval. Depending on the embodiment, the slack rules may be set by a user or administrator 290.

Besides forecast and intraday slack periods, slack periods may be further characterized as either short or long. Generally, a short slack period may be a slack period that is less than a threshold period length and a long slack period may be a slack period that is greater than the threshold period length. For example, a slack rule that matches short slack periods may be: staffing is >=X staffing (default X=5) for a 30 minute period. As another example, a slack rule that matches long slack periods may be: staffing is >=X staffing (default X=5) for X % (default X=75%) of an interval for >than a 30 minute period.

Intraday slack periods may be slack periods that are predicted for a current day on a real-time or near real-time basis. The slack predictor 220 may predict an intraday slack period for an interval using performance statistics 217 that are collected about the contact center 150, including the queues, about how busy the contact center 150 has recently been. The statistics 217 may be collected and provided by the WFM application 154. Depending on the embodiment, the statistics 217 may include interaction volume, handle times, and service levels. Other statistics 217 may be collected.

The slack predictor 220 may detect an intraday slack period by comparing the workload predicted for an interval by the forecast 216 and the actual observed workload as indicated by the statistics 217. For example, if the statistics 217 show that an interval was much less busy than expected in the forecast 216, the slack predictor 220 may determine that an upcoming interval is likely to be a slack period. Similarly as described above with respect to the forecast slack periods, the slack predictor 220 may predict an intraday slack period for one or more intervals using one or more slack rules.

After detecting or predicting a slack period, the slack predictor 220 may send a request 246 to the administrator 290 asking the administrator 290 to either confirm or reject the slack period. For example, the slack predictor 220 may send the administrator 290 an email with links that the administrator 290 can use to confirm or reject the slack period. The request 246 may also include information about the slack period such as its predicted length, severity, and the particular slack rules that were used to predict the slack period. If the administrator 290 approves the slack period they may provide a confirmation 255 to the slack predictor 220, else the administrator 290 may provide a rejection 256.

The received confirmation 255 or rejection 256 may be used by the slack predictor 220 to update one or more tolerances related to the slack rules that predicted the associated slack period. For example, if a slack rule such as “staffing is overstaffed >=5 staffing for a 30 minute period” was used to predict the slack period that received a rejection 256, the slack predictor 220 may make the rule more restrictive by increasing the number of overstaffed agents 120 to 6 from 5, or by increasing the duration from 30 to 35 minutes.

Similarly, if the slack period received a confirmation 255, the slack predictor 220 may either leave the slack rule alone or may make the rule less restrictive by decreasing the number of overstaffed agents 120 to 5 from 4, or by decreasing the duration from 30 to 25 minutes. As may be appreciated, by changing the tolerances of the slack rules based on feedback from the administrator 290, the slack predictor 220 learns and implements the preferences of the administrator 290 with respect to slack periods without the administrator 290 having to explicitly create or edit any slack rules. Depending on the embodiment, the slack rules may initially have default tolerances that are based on industry standards, for example.

In some implementations, each predicted slack period may be associated with a confidence value that indicates how confident the slack predictor 220 is that the predicted slack period is correct. In such embodiments, rather than have the administrator 290 approve or confirm each slack period, the slack predictor 220 may only send requests 246 for slack periods whose associated confidence is below a threshold. The threshold value may be set by the administrator 290, for example.

The notification engine 230 may send notifications 245 to one or more agents 120 in response to a predicted (and confirmed) slack period. The notification 245 may be an electronic message (e.g., email or SMS) and may be sent to each agent 120 associated with the slack period. The notification 245 may be sent to every agent 120 scheduled to work during an interval covered by the slack period, or to every agent 120 scheduled to work on a particular queue and interval covered by the slack period.

Each notification 245 sent to an agent 120 may include identifiers of one or more tasks 257 that the agent 120 could complete during the slack period. The tasks 257 may be QM tasks such as performing a self-evaluation, meeting with a supervisor, receiving coaching, or taking one or more classes or courses. In some implementations, the notification engine 230, upon receiving the slack period, may determine each of the agents 120 that are scheduled to work during an interval associated with the slack period. The notification engine 230 may then interface with the QM application 155 to determine any QM tasks that are associated with each agent 120, and that may be completed by the agents 120 during the slack period. For example, a short slack period may be suitable in length for an agent 120 to perform a self-evaluation, but not long enough for the agent 120 to receive coaching. The determined tasks 257 for each agent 120 may be included in their respective notification 245. Depending on the embodiment, before the notification engine 230 includes a task 257 such as coaching by a supervisor in the notification 245, the notification 230 may interface with the WFM application 154 to determine that the supervisor is available during the interval(s) associated with the slack period.

In some embodiments, the notification engine 230 may further send notifications 245 to supervisors whose agents 120 are working during a slack period. The notification 245 may encourage the supervisors to accept requests for coaching from their agents 120 during the slack period. Prior to sending the notification 245, the notification engine 230 may interface with the WFM application 154 to determine if the supervisor is free and not other wise scheduled during the interval(s) associated with the slack period prior to sending the notification 245.

In some embodiments, the notification engine 230 may display slack periods where agents 120 are scheduled to work as events on one or more calendars associated with each agent 120. The event for an agent 120 may include identifiers of any tasks 257 that may be completed by the agent 120 during the slack period. Similarly, the slack periods may be displayed as events in the calendars of supervisors and may identify the agents 120 associated with each slack period.

In some embodiments, the notification engine 230 may include one or more incentives for the agents 120 to schedule tasks 257 during the slack periods. The incentives may include points that each agent 120 can accumulate over time. The points accumulated by each agent 120 may be considered by supervisors when determining agents 120 to promote, when considering which agents 120 to award with popular shifts, and when determining whether or not to approve time off or vacation requests. Any type of incentive may be used.

In particular, the notification engine 230 may calculate and maintain a slack score for each agent 120 that meant to reflect the willingness of the agent 120 to accommodate slack periods. As an example, the slack score for an agent 120 may be calculated using criteria. The particular weight that each criterion receives when calculating the slack score may be set by the administrator 290.

For example, the notification engine 230 may calculate the slack score for each agent using the following criteria: A. Self-evaluations completed during short or long slack times (default 1 point each); B. Coaching content reviewed during short or long slack times (default 2 points each); C. Coaching sessions attended during long slack period (default 3 points); D. Break moved into a slack period (default 4 points per minute); and E. Voluntary time off requested in advance of a forecasted slack period (default 5 points per minute).

The notification engine 230 may use the criteria collected above to calculate the slack score of each agent 120 according to the following formula:

Slack Period Score=(Sum of A)+(Sum of B)+C+(Minutes*D)+(Minutes*E)

For example, if an agent completed 2 self-evaluation, reviewed 1 set of coaching content assigned to him/her, and moved a 30 minute lunch break into a slack period, the score would be: (2*1)+2+0+120+0=124. The scores for each agent 120 may be added/summed into a single slack score per day and may be aggregated into a weekly and/or monthly total score to use for rewards. Note that particular values associated to each criterion may be set by the administrator 290.

The notification engine 230 may export this score as well as make it accessible through API's so it can be connected to other systems (e.g., Performance Management) to provide different rewards that a customer chooses. Some examples of the rewards may include additional time off and rank improvement where that rank gives the employees higher priority for requests in WFM or other systems. A variety of incentives may be used.

The notification engine 230 may monitor the number of agents 120 that elect to work on a task 257 during a slack period to ensure that the performance of the queue or contact center 150 is not negatively affected. For example, a slack period may be associated with an excess of four agents 120 for the period. Accordingly, once four agents 120 have elected to perform QM tasks 257, the notification engine 230 may no longer permit agents 120 to work on a task 257 during the slack period.

The notification engine 230 may automatically schedule agents 120 to QM tasks 257 during a slack period. The notification engine 230 may determine agents 120 scheduled to work during the slack period and may determine tasks 257 associated with the determined agents 120. The notification engine 230 may add the determined tasks 257 to the schedules 215 of some or all of the determined agents 120.

The notification engine 230 may further notify one or more supervisors about a determined slack period. The notification 245 may include information about the determined slack period such as the duration and severity of the slack period. The notification 245 may further identify agents 120 that are working during the slack period along with QM tasks 257 that may be associated with the agents 120. The notification 245 may encourage the supervisors to accept meeting requests with the agents 120 during the intervals associated with the identified slack period.

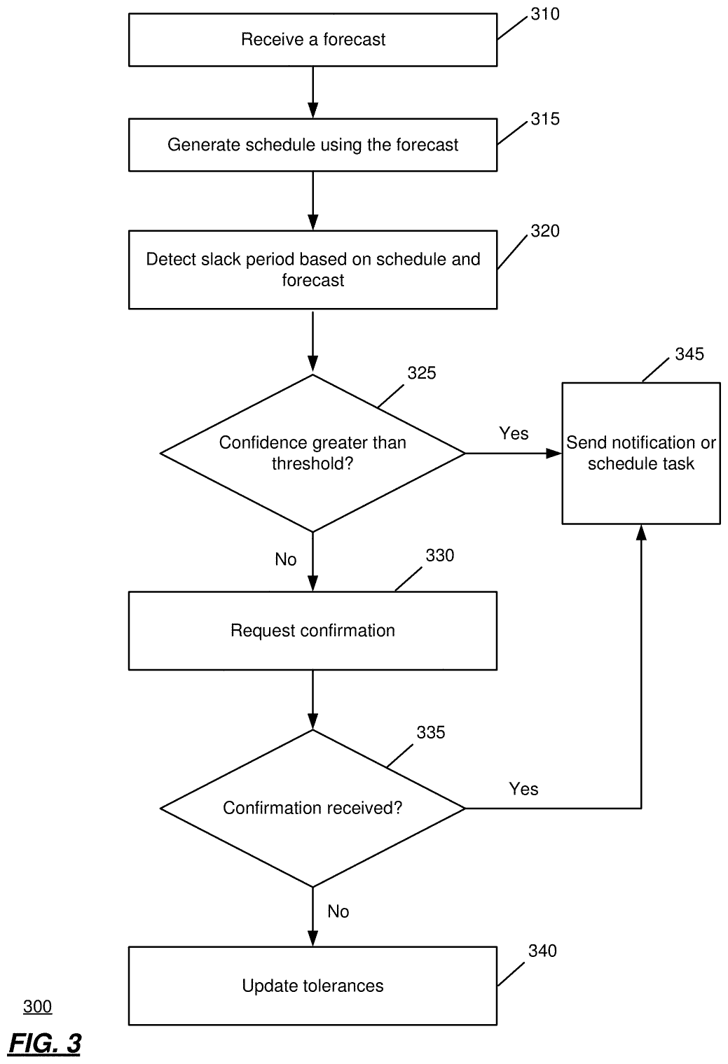

FIG. 3 is an illustration of an example method 300 for predicting one or more forecast slack periods. The method 300 may be implemented by the slack engine 210 of the contact center 150.

At 310, a forecast is received. The forecast 216 may be received by the slack predictor 220 from the WFM application 154. The forecast 216 may be for a plurality of intervals of a contact center 150.

At 315, a schedule is generated using the forecast. The schedule 215 may be generated by the WFM application 154 from the forecast 216. The schedule 215 may associate agents 120 with intervals of the plurality of intervals. The schedule 215 may be associated with the contact center 150, particular queues, or even agent 120 skill sets. Any method for generating a schedule 215 may be used.

At 320, a slack period is detected based on the schedule and the forecast. The slack period may be a forecast slack period and may be detected by the slack predictor 220 using one or more slack rules. The slack period may be associated with a confidence value.

At 325, whether the confidence is greater than a threshold is determined. The determination may be made by the slack predictor 220. If the confidence is greater than the threshold then the method 300 may continue at 345. Else, the method 300 may continue at 330.

At 330, confirmation is requested. The confirmation may be requested by the slack predictor 220 sending a request 246 to the administrator 290.

At 335, whether confirmation was received is determined. The determination may be made by the slack predictor 220. If the confirmation 255 was received, then the method 300 may continue at 345. Else, a rejection 256 was received, and the method 300 may continue at 340.

At 340, one or more tolerances are updated. The one or more tolerances may be associated with the slack rules and may be updated based on whether or not a confirmation 255 or a rejection 256 was received.

At 345, a notification is sent. The notification 245 may be sent by the notification engine 230 to one or more agents 120 scheduled to work during the slack period. Each notification 245 may identify one or more QM tasks 257 that the associated agent 120 could complete during the slack period. Alternatively, or additionally, the notification engine 230 may automatically add one or more of the identified tasks 257 to the schedule 215 for the agent 120 to complete during the slack period.

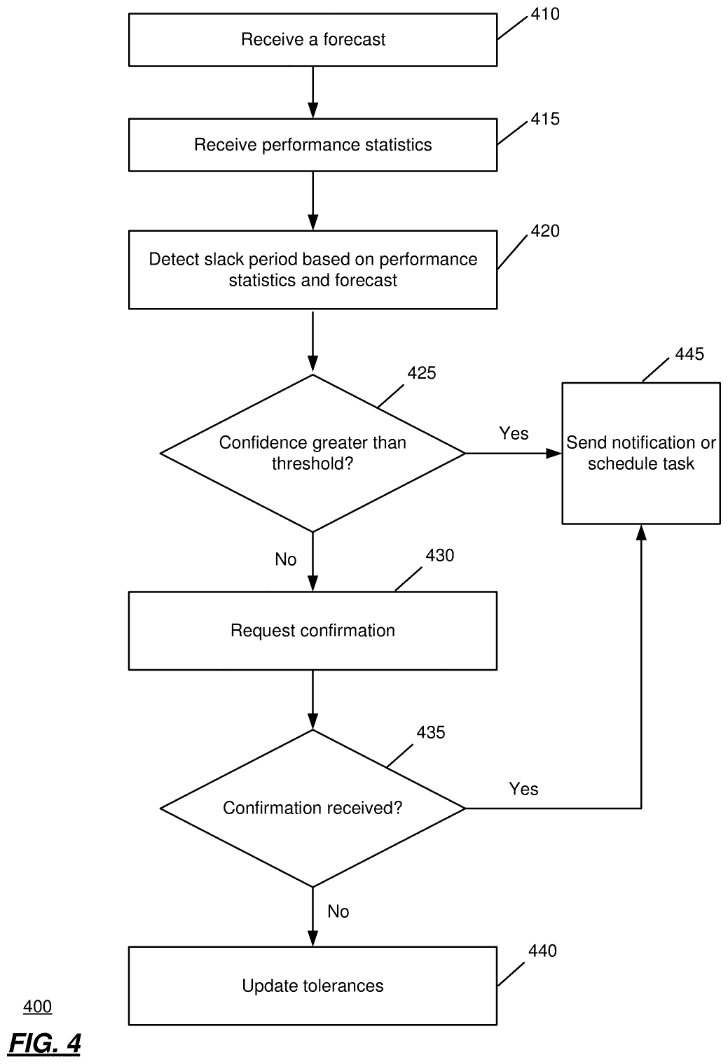

FIG. 4 is an illustration of an example method 400 for predicting one or more intraday slack periods. The method 400 may be implemented by the slack engine 210 of the contact center 150.

At 410, a forecast is received. The forecast 216 may be received by the slack predictor 220 from the WFM application 154. The forecast 216 may be for a plurality of intervals of a contact center 150.

At 415, performance statistics are received. The performance statistics 217 may be real or near real-time statistics about how busy the contact center 150 is for one or more intervals. The performance statistics 217 may be provided by the WFM application 154, for example.

At 420, a slack period is detected based on the forecast and the performance statistics. The slack period may be an intraday slack period and may be detected by the slack predictor 220 using one or more slack rules. The slack period may be associated with a confidence value.

At 425, whether the confidence is greater than a threshold is determined. The determination may be made by the slack predictor 220. If the confidence is greater than the threshold then the method 400 may continue at 445. Else, the method 400 may continue at 430.

At 430, confirmation is requested. The confirmation may be requested by the slack predictor 220 sending a request 246 to the administrator 290.

At 435, whether confirmation was received is determined. The determination may be made by the slack predictor 220. If the confirmation 255 was received, then the method 400 may continue at 445. Else, a rejection 256 was received, and the method 400 may continue at 440.

At 440, one or more tolerances are updated. The one or more tolerances may be associated with the slack rules and may be updated based on whether or not a confirmation 255 or a rejection 256 was received.

At 445, a notification is sent. The notification 245 may be sent by the notification engine 230 to one or more agents 120 scheduled to work during the slack period. Each notification 245 may identify one or more QM tasks 257 that the agent 120 could complete during the slack period. Alternatively, or additionally, the notification engine 230 may add one or more of the identified tasks 257 to the schedule 215 for the agent 120 to complete during the slack period.

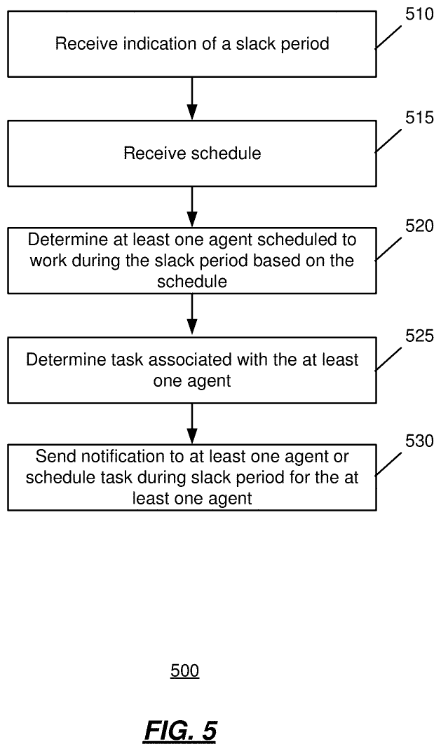

FIG. 5 is an illustration of an example method 500 for sending a notification in response to a slack period. The method 500 may be implemented by the slack engine 210 of the contact center 150.

At 510, an indication of a slack period is received. The indication may be received from the slack predictor 220 by the notification engine 230. The slack period may be associated with one or more intervals of a plurality of intervals.

At 515, a schedule is received. The schedule 215 may be received by the notification engine 230 from the WFM application 154. The schedule 215 may assign agents 120 to the plurality of intervals.

At 520, at least one agent scheduled to work during the slack period is determined. The at least one agent 120 may be determined by the notification engine 230 using the schedule 215.

At 525, a task associated with the at least one agent is determined. The task 257 may be determined by the notification engine 230 using the QM application 155. The task 257 may be a QM task such as performing a self-evaluation or receiving coaching.

At 530, notification is sent to the at least one agent. The notification 245 may be sent by the notification engine 230 to the at least one agent 120. The notification 245 may indicate the slack period to the at least one agent 120 along with the determined task 257. The agent 120 may schedule the task 257 through the notification 245. In some embodiments, the notification 245 may further include one or more incentives that the agent 120 may receive for performing the task 257 during the slack period. Alternatively, or additionally, the notification engine 230 may automatically schedule the task 257 for the at least one agent 120 during the slack period.

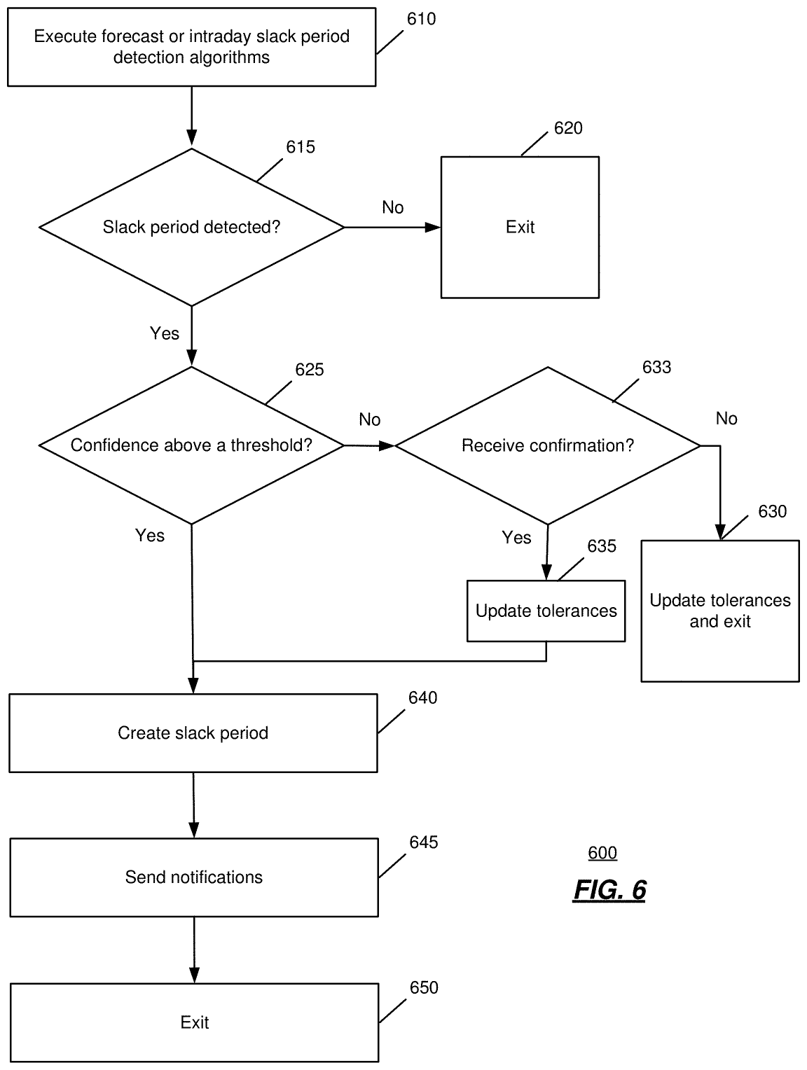

FIG. 6 is an illustration of an example method 600 for detecting a slack period and for sending notifications in response to the detected slack period. The method 600 may be implemented by the slack engine 210 of the contact center 150.

At 610, forecast or intraday slack detection algorithms are executed. The algorithms may be executed by the slack predictor 220 using one or more of a schedule 215, a forecast 216, statistics 217, and one or more slack rules.

At 615, whether a slack period is detected is determined. If the slack period is detected the method 600 may continue at 625. Else, the method 600 may exit at 620.

At 625, whether the confidence is above a threshold is determined. The determination may be made by the slack predictor 220. If the confidence is above the threshold then the method 600 may continue at 640. Else, the slack predictor 220 may send a request 256 to the administrator 290 for confirmation and the method 600 may continue at 633.

At 633, whether confirmation was received is determined. The determination may be made by the slack predictor 220. If the confirmation 255 was received, then the method 600 may continue at 635. Else, a rejection 256 was received, and the method 600 may continue at 630.

At 630, one or more tolerances are updated. The one or more tolerances may be associated with the slack rules and may be updated based on the rejection 256. After updating the tolerances, the method 600 may exit.

At 635, one or more tolerances are updated. The one or more tolerances may be associated with the slack rules and may be updated based on the confirmation 255.

At 640, a slack period corresponding to the detected slack period is created. The slack period may be created by the notification engine 230 adding the slack period to the schedule 215.

At 645, notifications are sent. The notifications 245 may be sent by the notification engine 230 to each agent 120 scheduled to work during the slack period. Each notification 245 may indicate the slack period to the agent 120 along with a task 257 associated with the agent 120. The task 257 may be a QM task such as a self-evaluation. After sending the notifications, the method 600 may exit at 650.

FIG. 7 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of tangible computer readable media. Computer readable media can be any available tangible media that can be accessed by device 700 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communications connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

Returning to FIG. 1, agent(s) 120 and customers 110 may communicate with each other and with other services over the network 130. For example, a customer calling on telephone handset may connect through the PSTN and terminate on a private branch exchange (PBX). A video call originating from a tablet may connect through the network 130 terminate on the media server. A smartphone may connect via the WAN and terminate on an interactive voice response (IVR)/intelligent virtual agent (IVA) components. IVR are self-service voice tools that automate the handling of incoming and outgoing calls. Advanced IVRs use speech recognition technology to enable customers to interact with them by speaking instead of pushing buttons on their phones. IVR applications may be used to collect data, schedule callbacks and transfer calls to live agents. IVA systems are more advanced and utilize artificial intelligence (AI), machine learning (ML), advanced speech technologies (e.g., natural language understanding (NLU)/natural language processing (NLP)/natural language generation (NLG)) to simulate live and unstructured cognitive conversations for voice, text and digital interactions. In yet another example, Social media, email, SMS/MMS, IM may communicate with their counterpart's application (not shown) within the contact center 150.

The contact center 150 itself be in a single location or may be cloud-based and distributed over a plurality of locations. The contact center 150 may include servers, databases, and other components. In particular, the contact center 150 may include, but is not limited to, a routing server, a SIP server, an outbound server, a reporting/dashboard server, automated call distribution (ACD), a computer telephony integration server (CTI), an email server, an IM server, a social server, a SMS server, and one or more databases for routing, historical information and campaigns.

The ACD is used by inbound, outbound and blended contact centers to manage the flow of interactions by routing and queuing them to the most appropriate agent. Within the CTI, software connects the ACD to a servicing application (e.g., customer service, CRM, sales, collections, etc.), and looks up or records information about the caller. CTI may display a customer's account information on the agent desktop when an interaction is delivered. Campaign management may be performed by an application to design, schedule, execute and manage outbound campaigns. Campaign management systems are also used to analyze campaign effectiveness.

For inbound SIP messages, the routing server may use statistical data from reporting/dashboard information and a routing database to the route SIP request message. A response may be sent to the media server directing it to route the interaction to a target agent 120. The routing database may include: customer relationship management (CRM) data; data pertaining to one or more social networks (including, but not limited to network graphs capturing social relationships within relevant social networks, or media updates made by members of relevant social networks); agent skills data; data extracted from third party data sources including cloud-based data sources such as CRM; or any other data that may be useful in making routing decisions.

The integration of real-time and non-real-time communication services may be performed by unified communications (UC)/presence sever. Real-time communication services include Internet Protocol (IP) telephony, call control, instant messaging (IM)/chat, presence information, real-time video and data sharing. Non-real-time applications include voicemail, email, SMS and fax services. The communications services are delivered over a variety of communications devices, including IP phones, personal computers (PCs), smartphones and tablets. Presence provides real-time status information about the availability of each person in the network, as well as their preferred method of communication (e.g., phone, email, chat and video).

Recording applications may be used to capture and play back audio and screen interactions between customers and agents. Recording systems should capture everything that happens during interactions and what agents do on their desktops. Surveying tools may provide the ability to create and deploy post-interaction customer feedback surveys in voice and digital channels. Typically, the IVR/IVA development environment is leveraged for survey development and deployment rules. Reporting/dashboards are tools used to track and manage the performance of agents, teams, departments, systems and processes within the contact center. Reports are presented in narrative, graphical or tabular formats. Reports can be created on a historical or real-time basis, depending on the data collected by the contact center applications. Dashboards typically include widgets, gadgets, gauges, meters, switches, charts and graphs that allow role-based monitoring of agent, queue and contact center performance. Unified messaging (UM) applications include various messaging and communications media (voicemail, email, SMS, fax, video, etc.) stored in a common repository and accessed by users via multiple devices through a single unified interface.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a forecast for an entity by a computing device, wherein the forecast comprises a predicted workload for each interval of a plurality of intervals;
generating a schedule for the entity by the computing device using the forecast by the computing device, wherein a schedule comprises the plurality of intervals, and identifications of agents of a plurality of agents assigned to each interval of the plurality of periods;
based on the schedule and the forecast, detecting a slack period in at least one interval of the plurality of intervals by the computing device; and
in response to the detected slack period, requesting that an administrator confirm the detected slack period by the computing device.

2. The method of claim 1, further comprising:
receiving a confirmation of the detected slack period; and
sending a notification to each of one or more agents about the detected slack period.

3. The method of claim 2, further comprising:
updating one or more tolerances associated with detecting the slack period in response to receiving the confirmation.

4. The method of claim 2, wherein sending the notification to each of the one or more agents about the detected slack period comprises:
determining tasks assigned to each of the one or more agents; and
including information about the tasks in the notification.

5. The method of claim 4, further comprising including information about an incentive for performing one or more tasks of the determined tasks during the at least one interval associated with the detected slack period in the notification.

6. The method of claim 4, wherein the tasks comprise self-evaluation tasks or self-improvement tasks.

7. The method of claim 1, further comprising:
receiving a rejection of the detected slack period; and
updating one or more tolerances associated with detecting the slack period in response to receiving the rejection.

8. The method of claim 1, further comprising:
determining a confidence value associated with the slack period; and
only requesting that the administrator confirm the detected slack period when the determined confidence value is below a threshold.

9. The method of claim 1, wherein each agent of the plurality of agents is associated with one or more skills of a plurality of skills, the slack period is associated with one or more skills of the plurality of skills, and further comprising:
determining one or more agents associated with the same one or more skills as the slack period; and
sending a notification to each of the determined one or more agents about the detected slack period.

10. The method of claim 1, further comprising:
determining an agent of the plurality of agents assigned to the at least one interval associated with the slack period;
determining a supervisor of the determined agent;
determining if the supervisor is available during the at least one interval; and
if it is determined that the supervisor is available during the at least one interval, sending a notification to the determined agent to perform a coaching task with the supervisor during the at least one interval.

11. A system comprising:
at least one processor; and
a non-transitory computer readable medium comprising instructions that, when executed by the at least one processor, cause the system to:
receive a forecast for an entity, wherein the forecast comprises a predicted workload for each interval of a plurality of intervals;
generate a schedule for the entity using the forecast by the computing device, wherein a schedule comprises the plurality of intervals, and identifications of agents of a plurality of agents assigned to each interval of the plurality of periods;
based on the schedule and the forecast, detect a slack period in at least one interval of the plurality of intervals; and
in response to the detected slack period, request that an administrator confirm the detected slack period.

12. The system of claim 11, further comprising instructions that, when executed by the at least one processor, cause the system to:
receive a confirmation of the detected slack period; and
send a notification to each of one or more agents about the detected slack period.

13. The system of claim 12, further comprising instructions that, when executed by the at least one processor, cause the system to:
update one or more tolerances associated with detecting the slack period in response to receiving the confirmation.

14. The system of claim 12, wherein sending the notification to each of the one or more agents about the detected slack period comprises:
determining tasks assigned to each of the one or more agents; and
including information about the tasks in the notification.

15. The system of claim 14, further comprising including information about an incentive for performing one or more tasks of the determined tasks during the at least one interval associated with the detected slack period in the notification.

16. The system of claim 14, wherein the tasks comprise self-evaluation tasks or self-improvement tasks.

17. The system of claim 11, further comprising instructions that, when executed by the at least one processor, cause the system to:
receive a rejection of the detected slack period; and
update one or more tolerances associated with detecting the slack period in response to receiving the rejection.

18. The system of claim 11, further comprising instructions that, when executed by the at least one processor, cause the system to:
determine a confidence value associated with the slack period; and
only request that the administrator confirm the detected slack period when the determined confidence value is below a threshold.

19. The system of claim 11, wherein each agent of the plurality of agents is associated with one or more skills of a plurality of skills, the slack period is associated with one or more skills of the plurality of skills, and further comprising instructions that, when executed by the at least one processor, cause the system to:
determine one or more agents associated with the same one or more skills as the slack period; and
send a notification to each of the determined one or more agents about the detected slack period.

20. A non-transitory computer readable medium comprising instructions that, when executed by at least one processor, cause the at least one processor to:
receive a forecast for an entity, wherein the forecast comprises a predicted workload for each interval of a plurality of intervals;
generate a schedule for the entity using the forecast by the computing device, wherein a schedule comprises the plurality of intervals, and identifications of agents of a plurality of agents assigned to each interval of the plurality of periods;
based on the schedule and the forecast, detect a slack period in at least one interval of the plurality of intervals; and
in response to the detected slack period, request that an administrator confirm the detected slack period.
